(19) United States
(12) Patent Application Publication
(10) Pub. No.: US 2026/0238156 A1
(43) Pub. Date: Aug. 13, 2026

(54) SHARE ATTACHMENT SOLAR MOUNTING SYSTEM FOR FLAT ROOFS

(71) Applicant: Pegasus Solar Inc, Richmond, CA (US)

(72) Inventors: Erich Kai Stephan, Richmond, CA (US); James Hsieh, Richmond, CA (US); Ian Wogan, Richmond, CA (US); Ian Lennox, Richmond, CA (US)

(21) Appl. No.: 19/534,426

(22) Filed: Feb. 9, 2026

Related U.S. Application Data
(60) Provisional application No. 63/757,240, filed on Feb. 11, 2025.

(51) Int. Cl. H02S 20/24

(52) U.S. Cl. CPC H02S 20/24

(57) ABSTRACT

A mounting system for mounting a plurality of solar modules to a surface is disclosed. The system may include a plurality of rails. The system may further comprise a plurality of module clamps adapted to mount solar modules to the rails, in which a first solar module is mounted to a first rail by a first one of the module clamps and a second solar module is mounted to a second rail by a second one of the module clamps. The system may further include at least one shared mount with two opposing distal ends each including a leg that extends upward from the respective distal end. The system may further comprise one or more roof anchors each adapted to anchor the at least one shared mount to the surface.

### CROSS-REFERENCE TO RELATED APPLICATIONS

The present patent application claims the priority benefit of U.S. provisional patent application no. 63/757,240 filed Feb. 11, 2025, the disclosure of which is incorporated by reference herein.

### BACKGROUND OF THE INVENTION

### 1. Field of the Art

The present invention generally relates to solar mounting systems and more specifically to share attachment solar mounting system for flat roofs.

### 2. Description of the Related Art

Currently, solar modules are attached to flat rooftops with an excessive number of roof penetrations. The present invention demonstrates a system that allows multiple structural beams to share a single attachment point to a rooftop, thereby reducing the quantity of roof penetrations.

### SUMMARY OF THE CLAIMED INVENTION

Embodiments of the present invention may include a mounting system for mounting a plurality of solar modules to a surface, the system comprising a plurality of rails. The system may further comprise a plurality of module clamps adapted to mount solar modules to the rails, in which a first solar module is mounted to a first rail by a first one of the module clamps and a second solar module is mounted to a second rail by a second one of the module clamps. The system may further comprise at least one shared mount with two opposing distal ends each including a leg that extends upward from the respective distal end, is secured to one of the rails, and attaches to one of the first module clamp and the second module clamp. The system may further comprise one or more roof anchors each adapted to anchor the at least one shared mount to the surface.

Embodiments of the present invention may include a mounting device comprising a spanning beam having a first end and a second end opposite the first end. The mounting device may further comprise a first leg and a second leg, the first leg adapted to be mounted to the first end and the second leg adapted to be mounted to the second end. The mounting device may further comprise one or more fasteners adapted to secure the first leg to the first end and the second leg to the second end.

### BRIEF DESCRIPTION OF THE DRAWINGS

FIG. 1 depicts an isometric view of a solar array on a roof surface.

FIG. 2 is a side close-up view of a solar array.

FIG. 3 is a top-down view of a solar array installed on a roof surface.

FIG. 4A is an isometric view of a solar array.

FIG. 4B depicts a side view of a solar array.

FIG. 4C illustrates a bottom view of the roof surface.

FIGS. 5A and 5B depict alternative views of a solar array.

FIG. 6 is an isometric view of a tall leg or a short leg.

FIG. 7 is an isometric view of a shared mount.

FIG. 8 depicts an isometric view of an alternative embodiment of a shared mount.

FIG. 9 is an isometric view of a shared mount.

FIG. 10 is a close up view of one end of a shared mount.

FIG. 11A is an isometric view of an alternative embodiment of a shared mount.

FIG. 11B is an exploded view of an alternate embodiment of a shared mount.

FIG. 12A depicts an isometric view of an alternative embodiment of a shared mount spanning beam.

FIG. 12B depicts an isometric view of an alternative embodiment of a shared mount spanning beam.

FIG. 12C depicts an isometric view of a plurality of shared mount spanning beam.

FIGS. 13A and 13B depict exemplary configurations of a shared mount.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

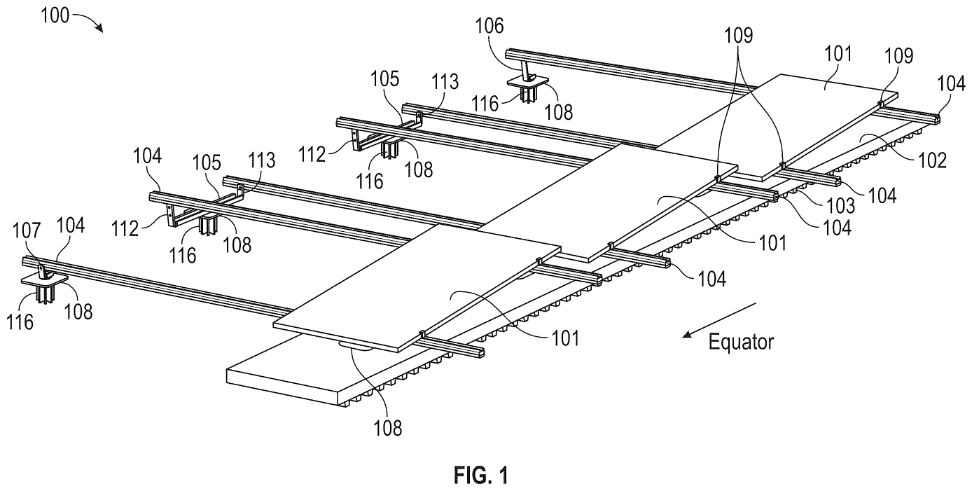

FIG. 1 depicts an isometric view of solar array 100 on roof surface 102, representing one example embodiment of the present invention. As depicted, roof surface 102 is cut-away to better depict the underlying roof structure 103, and to show a plurality of anchor fasteners 116 on a far-left side of solar array 100, though roof surface 102 would be under the entire area of solar array 100. Only one column of solar module 101 is depicted, but most solar arrays 100 may have solar modules 101 placed along the entire length of rails 104. A plurality of rails 104 may be disposed along the length of a roof surface 102 in rows, as depicted. In a first row of rail 104, one or more short legs 107 are secured to roof structure 103 using a roof anchor 108, and the one or more rails 104 are secured to at least two short legs 107. A next rail 104 is secured to one or more shared mount tall flange 112 that extends up from a shared mount 105. The distance between a first rail 104 and a second rail 104 may be such that a first rail 104 is positioned under a first 10% to 40% of the length of a solar module 101, and a second rail 104 is positioned under a first 60% to 90% of the length of a solar module 101. In this way, a solar module 101 may cantilever over a rail 10 to 40% of the length of the solar module 101. A third rail 104 may be secured to one or more share mount short flanges 113 extending up from shared mount 105. A first side of a second row of solar modules 101 connects to the third rail 104. One or more roof anchors 108 may secure each shared mount 105 to roof structure 103 using a plurality of anchor fasteners 116. In this way, two rows of solar modules 101 are secured to roof structure 103 using a single roof anchor 108 for each shared mount 105. Additional rows of solar modules 101 continue this pattern until a final row of solar modules 101, wherein a last rail 104 in a solar array 100 is secured to a roof structure 103 using one or more tall legs 106. Tall legs 106 may position rail 104 above roof surface 102 a substantially similar distance as shared mount tall flange 112. Short leg 107 may position an attached rail 104 substantially similar distance above roof surface 102 as shared mount short flange 113.

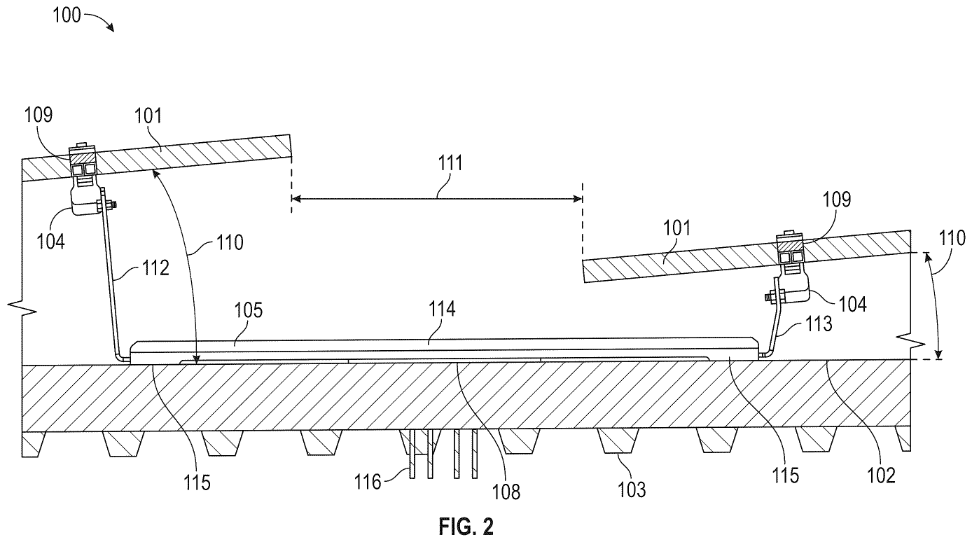

FIG. 2 is a side close-up view of Solar array 100 depicted as a single shared mount 105 supporting two rails 104 and connected to roof structure 103 using one roof anchor 108, representing one example embodiment of the present invention. Shared mount tall flange 112 and shared mount short flange 113 may extend up from shared mount spanning beam 114 so that the distal ends where a rail 104 attaches to are at module angle 110. Module angle 110 may be substantially similar for rails 104 and solar modules 101 attached to the shared mount tall flange 112 and shared mount short flange 113, respectively. One or more apertures not shown in shared mount 105 may connect shared mount 105 to roof anchor 108, said apertures located within the middle one-third of the length along shared mount spanning beam 114. Upon installing a first row of solar module 101 and a second row of solar module 101, shared mount 105 may be configured to yield an inter-row spacing 111 as measured between the edges of both rows of solar modules 101, as depicted. Inter-row spacing 111 may be between six and twenty inches, with some configurations having inter-row spacing 111 be between eight and sixteen inches. Module angle 110 may be between zero to fifteen degrees.

FIG. 2 also depicts a plurality of anchor fasteners 116 extending through roof surface 102 and through roof structure 103. One or more anchor fasteners 116 may be a self-drilling and tapping fastener, ranging in diameter from 0.15 to 0.35 inches, and may be configured to extend up to 0.25 inches beyond the lowest section of roof structure 103.

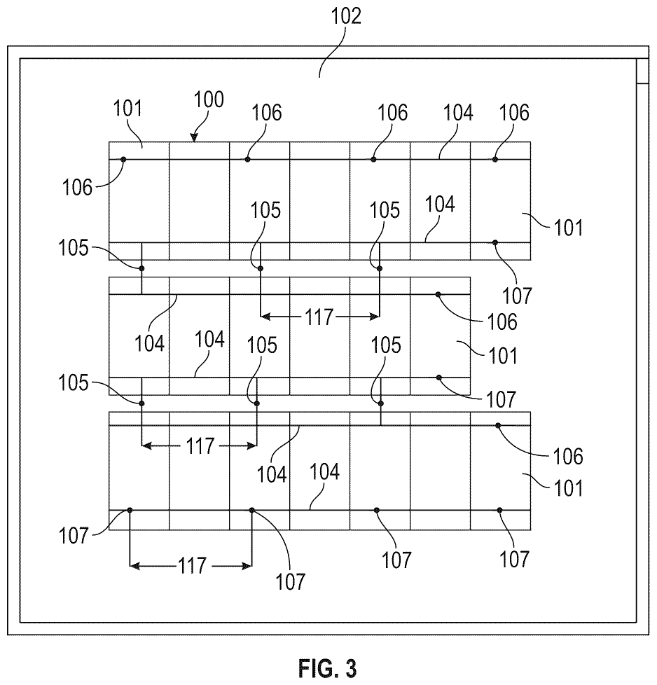

FIG. 3 is a top-down view of a Solar array 100 installed on a roof surface 102 with three rows of tall leg 106 with the middle row having fewer tall leg 106 compared to the first and third row, representing one example embodiment of Solar array 100. As depicted, a plurality of shared mount 105 are disposed on roof surface 102 in areas where a shared mount 105 can connect to two rail 104. When the cantilever of a rail 104 beyond a shared mount 105 to support a final solar module 101 in a row of solar module 101 is too large, such as shown on the right side of the middle row of solar module 101, a set of tall leg 106 and short leg 107 may be used. Shared mount 105, tall leg 106, or short leg 107 may have the same or a different maximum mount-to-mount span 117 within a row depending on external load factors, such as wind or snow loading. In some cases, the cantilever of rail 104 beyond a last shared mount 105, tall leg 106, or short leg 107 in a row of mounts may be less than or equal to 40% of mount-to-mount span 117 for that row. In some cases, mount-to-mount span 117 may be less than hinged connection 120 inches.

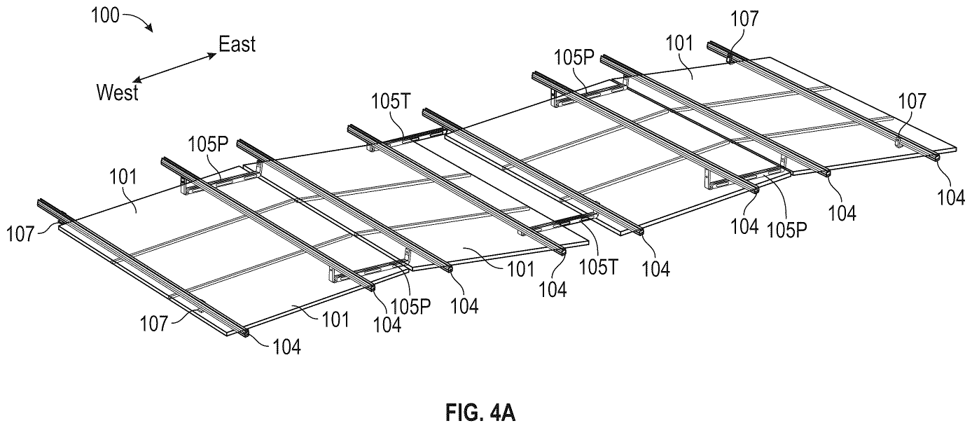

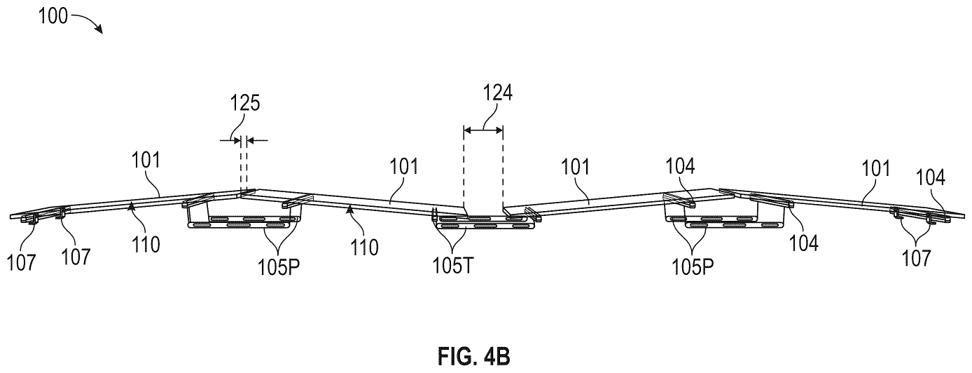

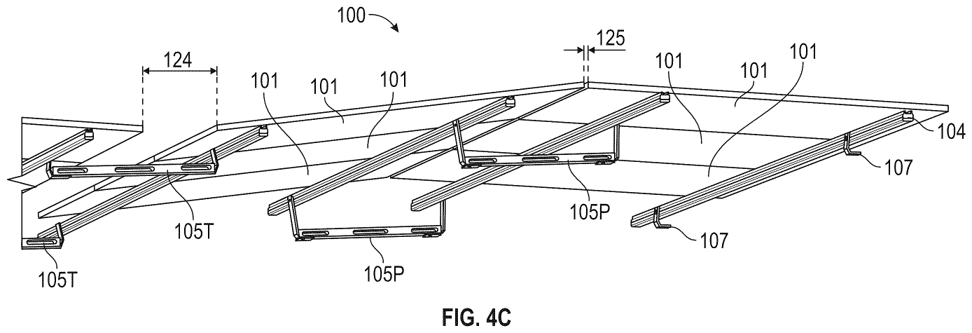

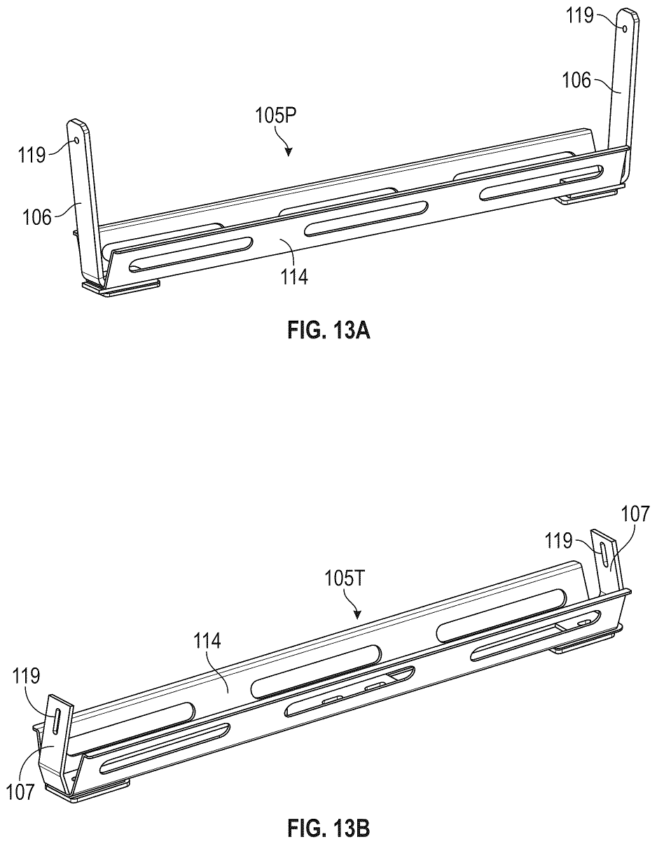

FIGS. 4A through 4C depict various views of solar array 100. A combination of shared mount 105P, shared mount 105T, and short leg 107 are used to arrange rows of solar module 101 in alternating opposing angles, representing an alternative embodiment of the present invention. As shown in FIG. 4A, rows of rail 104 are attached to either one or more short leg 107, one or more shared mount 105P, or one or more shared mount 105T. Typically, rows of the mounts will alternate where a first row is a row of short leg 107, then a next row is a row of shared mount 105P, then a next row is a row of shared mount 105T, then shared mount 105P, until a last row of mounts is again a row of short leg 107. In some embodiments, there may be one row of short leg 107, then a row of shared mount 105P, and then a final row of short leg 107. FIGS. 13A-13C have roof surface 102, roof structure 103, anchor fasteners 116, and roof anchor 108 hidden from view, but they would be used and employed in the same way as described in FIGS. 1-3.

FIG. 4B depicts a side view of Solar array 100, showing more clearly peak gap 125, trough gap 124, and module angle 110. Module angle 110 may be in opposite directions from row to row of solar module 101, as depicted, and may range from five to fifteen degrees. In most embodiments, a solar module 101 may be oriented so it is angled within fifteen degrees of their due West or due East. Peak gap 125 may range in size from 5 to 600 millimeters, and trough gap 124 may range in size from 5 to 600 millimeters. In some example embodiments, peak gap 125 and trough gap 124 may be different dimensions, for example peak gap 125 may be between 250 to 600 millimeters, and trough gap 124 may be between 5 and 50 millimeters, or vice versa.

FIG. 4C is from underneath roof surface 102 for additional depiction of the invention.

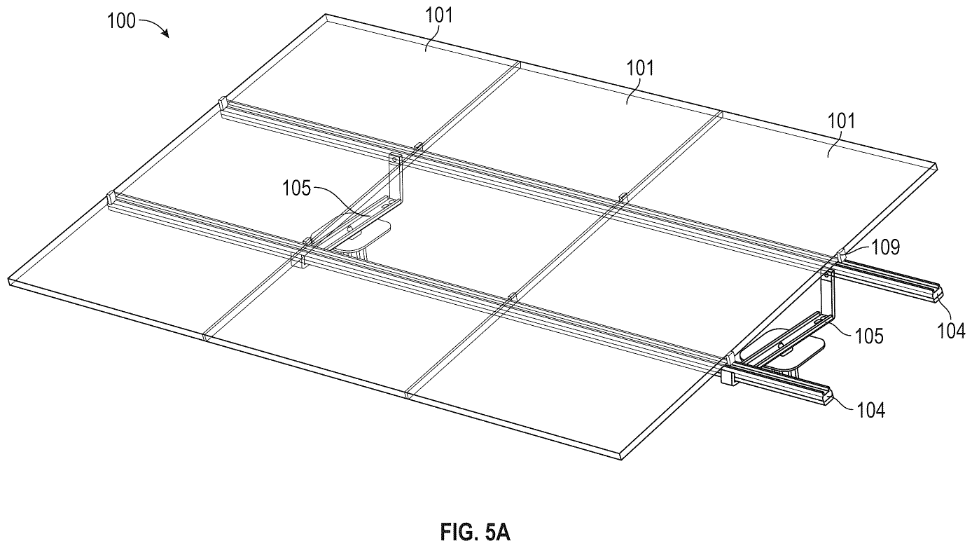

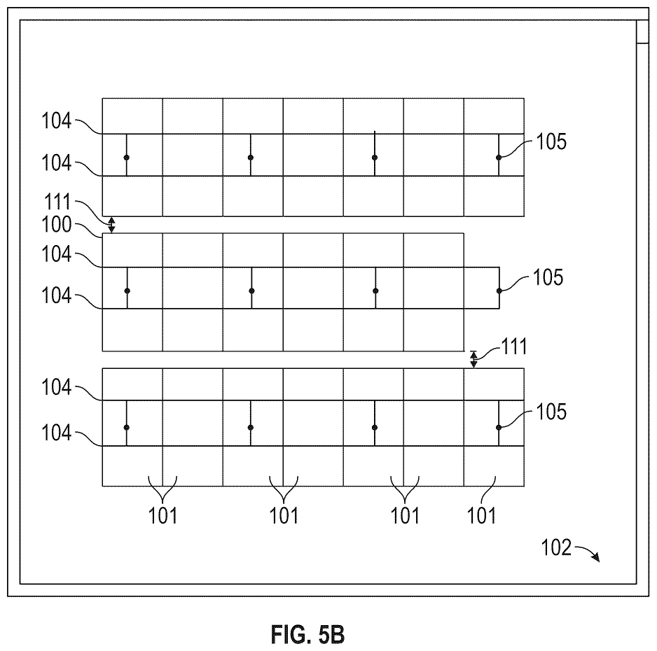

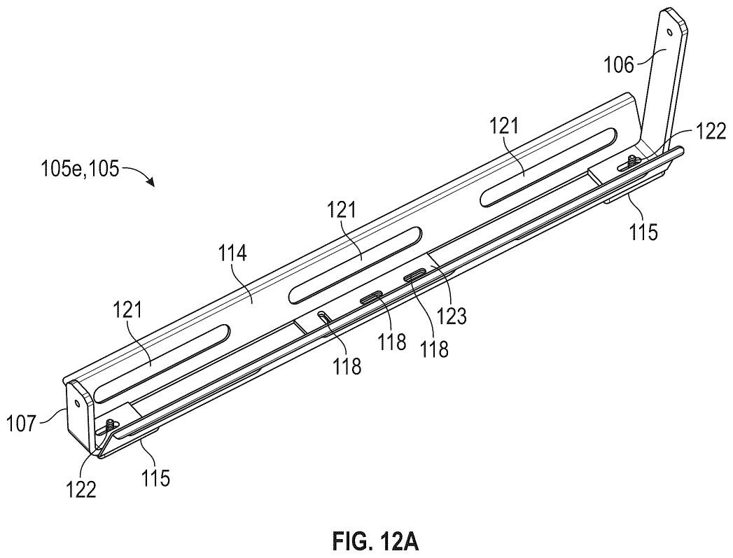

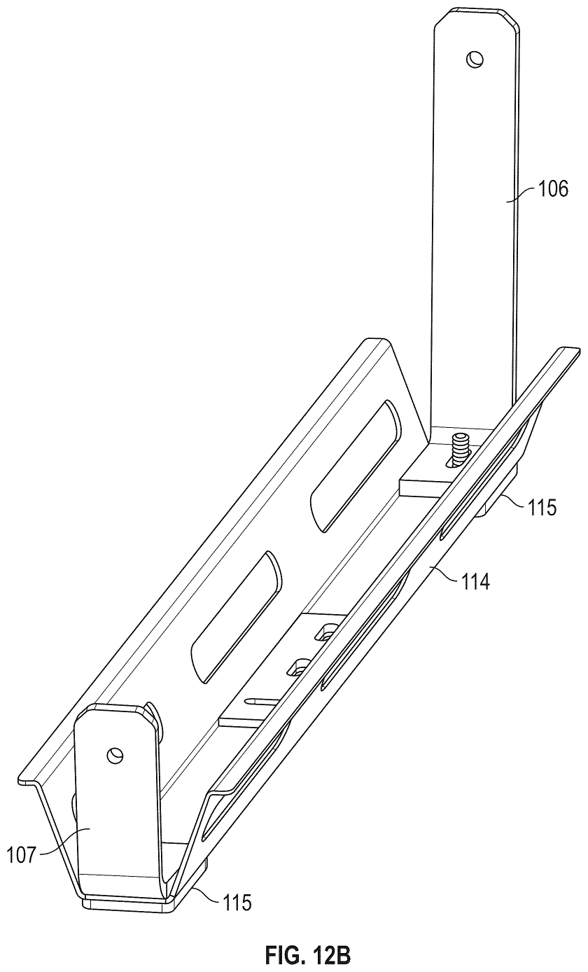

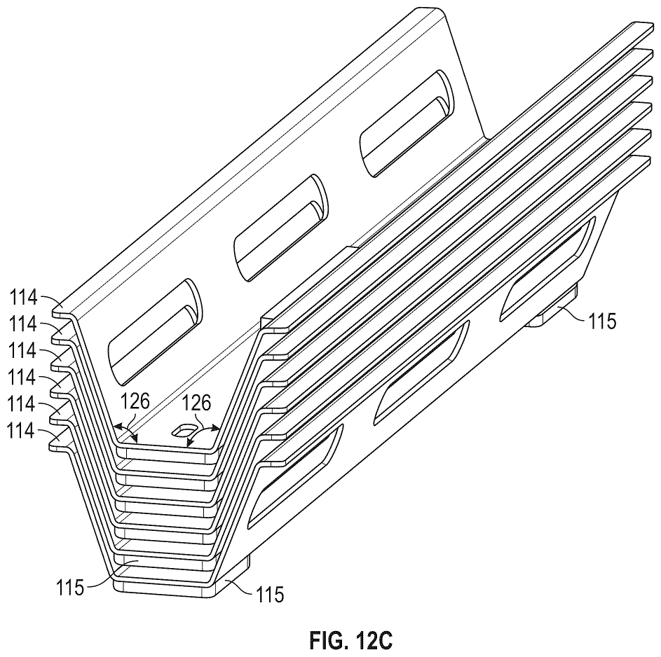

FIGS. 5A and 5B depict alternative views of a Solar array 100 wherein shared mount 105 is positioned to secure two rail 104 under a single for or solar module 101. In this example, shared mount 105 may be created from the components shown in FIGS. 12-13, or as a single body as depicted.

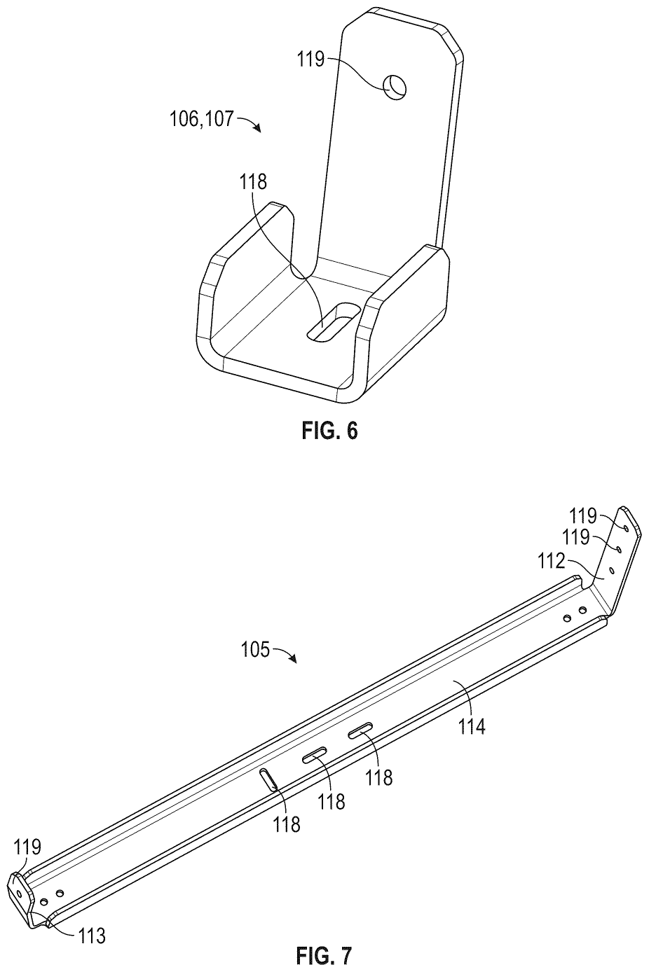

FIG. 6 is an isometric view of a tall leg 106 or a short leg 107, representing one example embodiment of the present invention. In this example, tall leg 106 has a rail attachment aperture 119 disposed near a distal end of a bent-up flange. rail attachment aperture 119 may be circular or a slot, with a width of seven to thirteen millimeters. On a main body, one or more anchor aperture 118 may be disposed, where anchor aperture 118 may be circular or a slot, with a width of seven to thirteen millimeters. One or more side flanges may extend up from either side of tall leg 106, as depicted. Tall leg 106 and short leg 107 may be formed from a uniform thickness piece of material, such as aluminum or steel, and may have a corrosion protection coating disposed on its surface, such as zinc, paint, powder coating, anodization, or galvanization.

FIG. 7 depicts an isometric view of shared mount 105, representing one example embodiment. In the bottom surface of shared mount spanning beam 114, one or more rail attachment aperture 119 may be disposed, where rail attachment aperture 119 may be circular or a slot, with a width of seven to thirteen millimeters. In some cases, one or more of the anchor aperture 118 configured as a slot may be oriented perpendicular to another anchor aperture 118 configured as a slot, as depicted. One or more side flanges may extend up from either side of shared mount spanning beam 114, as depicted. Shared mount 105 may be formed from a uniform thickness piece of material, such as aluminum or steel, and may have a corrosion protection coating disposed on its surface, such as zinc, paint, powder coating, anodization, or galvanization.

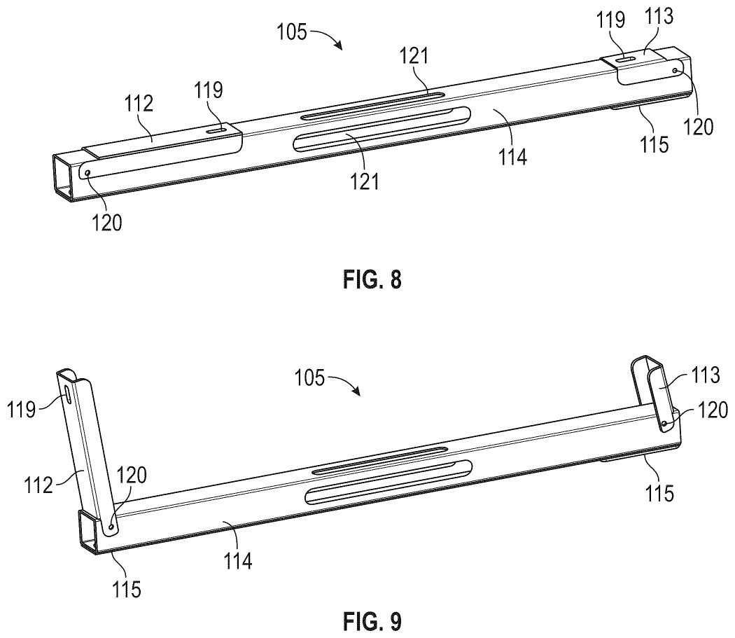

FIG. 8 depicts an isometric view of an alternative embodiment of shared mount 105 where shared mount tall flange 112 and shared mount short flange 113 are pre-installed with one or more hinged connection 120, representing another example embodiment of the present invention. shared mount tall flange 112 and shared mount short flange 113 may each pivotally connect to shared mount spanning beam 114, and fold down to a position wherein each is substantially parallel with the length of shared mount spanning beam 114. Hinged connection 120 may be a connection using a fastener, such as a bolt or screw, or a rivet. Shared mount tall flange 112 and shared mount short flange 113 may have one or more side flanges that extend down from their main bodies and configured to extend down on the outside of shared mount spanning beam 114, as depicted. One or more access port 121 may be positioned on one or more surfaces of shared mount spanning beam 114 and configured to allow a tool to pass through and access one or more anchor aperture 118 (not shown). In this example embodiment, shared mount spanning beam 114, shared mount short flange 113, and shared mount short flange 113 may be made from a pre-coated steel, such as pre-galvanized steel, with a thickness between 0.6 to 2.5 millimeters. Additional load bearing and distributing washers may be used at rail attachment aperture 119 and anchor aperture 118 to transfer loads from a rail 104 to shared mount 105 without yielding the material of shared mount 105. One or more pads 115 may be mechanically or adhesively connected to an underside of shared mount spanning beam 114, and may be made of an EPDM, TPO, or other suitable material.

FIG. 9 depicts the same example from FIG. 7, but with shared mount tall flange 112 and shared mount short flange 113 pivotally rotated around respective hinged connection 120 into a deployed position, ready to receive a rail 104 (not shown).

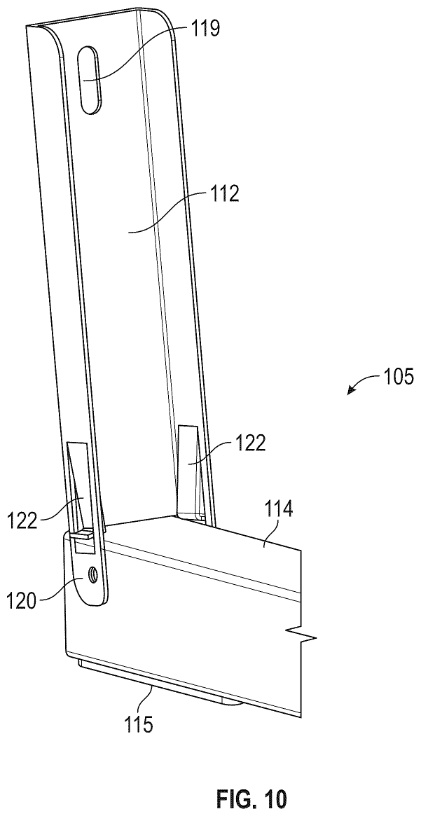

FIG. 10 is a close up view of one end of FIG. 9, depicting an alternative embodiment where in one or more beam-to-leg fastener 122 are formed into the surfaces of shared mount tall flange 112. When shared mount tall flange 112 is pivotally rotated into an upwards position, the one or more beam-to-leg fastener 122 may spring, traverse, flexibly, compressibly, or resiliently angle to interfere with a surface of shared mount spanning beam 114 such that shared mount tall flange 112 does not readily re-fold down into a collapsed position. Beam-to-leg fastener 122 may be configured to releasably or compressibly bend away, such as by hand force, to disengage with shared mount spanning beam 114 and allow for shared mount tall flange 112 to collapse back into a folded position as shown in FIG. 8.

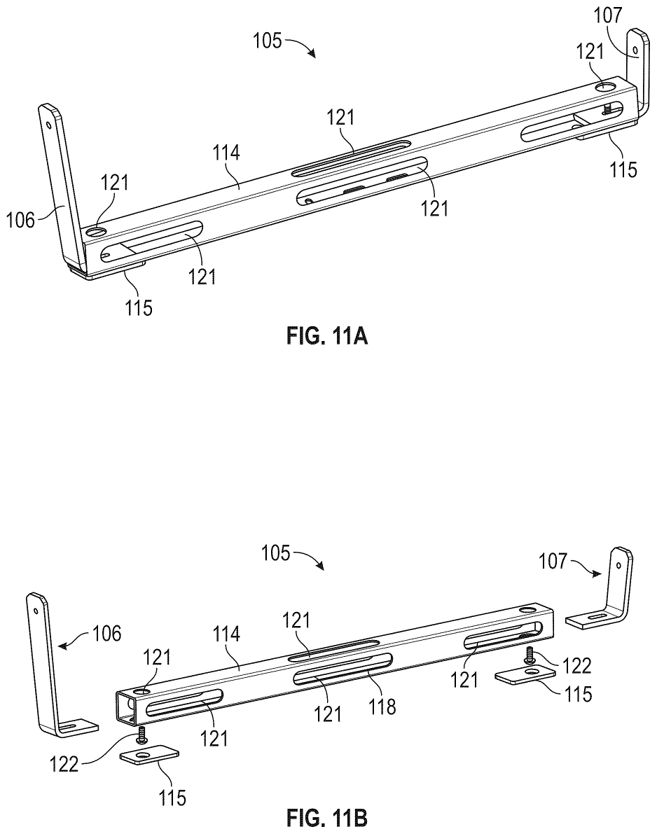

FIGS. 11A and 11B are isometric views of an alternative embodiment of shared mount 105 wherein shared mount tall flange 112 and shared mount short flange 113 are replaced with tall leg 106 and short leg 107, representing another example embodiment of the present invention. In this example embodiment, shared mount spanning beam 114 is a separate component, and a short leg 107 and tall leg 106 are installed on either distal end to act in the same form and function as shared mount tall flange 112 and shared mount short flange 113 as previously described. Shared mount spanning beam 114 may have a cavity disposed along its length, accessible from at least either end, configured to receive a flange of a tall leg 106 or a short leg 107. In other example embodiments not shown, one or more access port 121 disposed on a top surface of shared mount spanning beam 114 may be configured to allow a tall leg 106 or short leg 107 to pass through so that the tall leg 106 or short leg 107 can secure to a beam-to-leg fastener 122 disposed through a shared mount spanning beam 114. In other example embodiments not shown, an aperture disposed on either end of shared mount spanning beam 114 in the top side may be configured as a slot, and a beam-to-leg fastener 122 may secure a tall leg 106 or short leg 107 to the top surface of shared mount spanning beam 114.

One or more access port 121 may be positioned on one or more surfaces of shared mount spanning beam 114 and configured to allow a tool to pass through and access one or more anchor aperture 118 (not shown). In this example embodiment shared mount spanning beam 114 may be made from a pre-coated steel, such as pre-galvanized steel, with a thickness between 0.6 to 2.5 millimeters. Additional load bearing and distributing washers may be used in shared mount spanning beam 114 at anchor aperture 118 and the apertures for beam-to-leg fastener 122 to transfer loads from a rail 104 to shared mount 105 without yielding the material of shared mount spanning beam 114. One or more pad 115 may be mechanically or adhesively connected to an underside of shared mount spanning beam 114, and may be made of an EPDM, TPO, or other suitable material.

FIG. 11B depicts an exploded view of FIG. 11A in order to better depict the various components that may be used to assemble into shared mount 105. As shown in FIG. 10, beam-to-leg fastener 122 may be used from an underside or top side of shared mount spanning beam 114, accessible from one or more access port 121, and used to secure a tall leg 106 or short leg 107 to shared mount spanning beam 114. Pad 115 may mechanically or adhesively attach to an underside of shared mount spanning beam 114 and may have a relief aperture configure to avoid interference of pad 115 with beam-to-leg fastener 122. In this example embodiment, shared mount spanning beam 114 may be a rectangular tube with overlapping flanges on one side of the tube. In other example embodiments, shared mount spanning beam 114 may have trapezoidal cross section and may have an opening along its entire length.

FIGS. 12A through 12B depict isometric views of an alternative embodiment of shared mount spanning beam 114 where shared mount spanning beam 114 is a “V” shape with side walls at an obtuse to a bottom wall, representing another example of the present invention. On either distal end of shared mount spanning beam 114, a beam-to-leg fastener 122 may extend through an aperture in shared mount spanning beam 114 configured to receive a short leg 107 or a tall leg 106. The bottom surface of shared mount spanning beam 114 may be wide enough to fit the width of a tall leg 106 or short leg 107 but narrow enough to prevent a tall leg 106 or short leg 107 from rotating more than 10 degrees from parallel with the length of shared mount spanning beam 114. Load bearing plate 123 may have a similar pattern of anchor aperture 118 disposed in its surface to align with anchor aperture 118 formed in shared mount spanning beam 114. Load bearing plate 123 may be of a material and thickness to sufficiently disburse loads applied from the fastener of roof anchor 108 (not shown) and not damaging or yielding the material of shared mount spanning beam 114. Tall leg 106 and short leg 107 may be installed on top of the bottom surface of shared mount spanning beam 114 as shown, or they may be installed under shared mount spanning beam 114 and above pad 115, with a nut (not shown) threadably engaging onto beam-to-leg fastener 122 and tightening against the top side of a bottom surface of shared mount spanning beam 114.

Shared mount spanning beam 114 may be made from a uniform thickness material, such as sheet metal. All bends in shared mount spanning beam 114 may be formed with a radius greater than or equal to the thickness of the material of shared mount spanning beam 114. In some cases, shared mount spanning beam 114 may have a substantially uniform thickness between 1.0 to 4.0 millimeters. Shared mount spanning beam 114 may be made from a 5000-series aluminum, from a steel, a pre-galvanized steel, or other suitable material, and may have a coating on its primary flat surfaces, such as a paint, powder coat, anodization, or galvanization (primarily zinc). Shared mount spanning beam 114 may have a bottom surface, and two side flanges that extend up at obtuse angles, such as 45-80 degrees. One or more lateral flanges may extend laterally from the side flanges to improve resistant to buckling. A plurality of access port 121 may be disposed on the side flanges of shared mount spanning beam 114, aligned substantially with the neutral bending axis when shared mount spanning beam 114 is pulled up from both distal ends and secured in the middle at one or more anchor aperture 118.

FIG. 12C depicts an isometric view of a plurality of shared mount spanning beam 114 stacked and nested for transport, demonstrating a high packaging density, representing an example of the present invention. In this depicted, pad 115 are pre-installed to shared mount spanning beam 114, but in other examples, pad 115 may not be pre-installed to shared mount spanning beam 114, or they may be pre-installed to the bottom surfaces of tall leg 106 and short leg 107.

FIGS. 13A and 13B depict two other configurations of the example embodiment shown in FIG. 11, where a tall leg 106 is installed on either end of shared mount spanning beam 114 in FIG. 12A, and a tall leg 106 is installed on either end of shared mount spanning beam 114 in FIG. 12B. In the configuration in FIG. 12A, the face on tall leg 106 where rail attachment aperture 119 is located is angled away from the main centerline of shared mount spanning beam 114, as depicted. In the configuration in FIG. 12B, the face on short leg 107 where rail attachment aperture 119 is located is angled towards from the main centerline of shared mount spanning beam 114, as depicted. In some cases, the angle off centerline may be substantially the same, but in opposite directions. For example, the face on tall leg 106 may be at one-hundred degrees from the bottom face of shared mount spanning beam 114, and the face on short leg 107 may be at eighty degrees from the bottom face of shared mount spanning beam 114, or both at ten degrees from vertical in opposite directions. Combining FIGS. 11A, 11B and 12A-12C, what is presented is a set of components, the primary being shared mount spanning beam 114, tall leg 106, and short leg 107, that are configurable and interchangeable into three different configurations of shared mount 105, a single-sloped configuration shared mount 105E (FIG. 12A-12C), a peak configuration shared mount 105P (FIG. 13A), and a trough configuration shared mount 105T (FIG. 13B).

In all figures presented, the solar laminate, glass, photovoltaic cells, or energy capture interface of any solar module 101 may be hidden from view in order to better understand the present invention.

What is claimed is:

1. A mounting system for mounting a plurality of solar modules to a surface, the system comprising:
a plurality of rails;
a plurality of module clamps adapted to mount solar modules to the rails, wherein a first solar module is mounted to a first rail by a first one of the module clamps and a second solar module is mounted to a second rail by a second one of the module clamps;
at least one shared mount with two opposing distal ends each including a leg that:
extends upward from the respective distal end,
is secured to one of the rails, and
attaches to one of the first module clamp and the second module clamp; and
one or more roof anchors each adapted to anchor the at least one shared mount to the surface.

2. The mounting system of claim 1, wherein the leg extending from a first one of the distal ends of the shared mount has a different length than the leg extending from a second one of the distal ends.

3. The mounting system of claim 1, wherein the leg extending from a first one of the distal ends of the shared mount has a same length as the leg extending from a second one of the distal ends.

4. The mounting system of claim 1, wherein the module clamps are configured to mount the solar modules, and wherein 10% to 40% of a length of at least one of the solar modules cantilevers over one or more of the rails.

5. The mounting system of claim 1, wherein the leg extending from a first one of the distal ends is spaced from the leg extending from a second one of the distal ends so as to leave a space of between six and twenty inches between the first solar module and second solar module.

6. The mounting system of claim 1, wherein the leg extending from a first one of the distal ends and the leg extending from a second one of the distal ends are angled so as to cause the first solar module and the second solar module mounted to the shared mount to be angled in the same direction by between 0 and 15 degrees relative to the shared mount.

7. The mounting system of claim 1, wherein the leg extending from a first one of the distal ends and the leg extending from a second one of the distal ends are angled so as to cause the first solar module and the second solar module mounted to the shared mount to be angled in opposite directions by between 0 and 15 degrees relative to the shared mount.

8. The mounting system of claim 1, wherein the shared mount is formed from a piece of aluminum or steel of uniform thickness.

9. The mounting system of claim 1, wherein the shared mount has a corrosion protection coating of zinc, paint, or a powder coating, or is corrosion protected by anodization or galvanization.

10. A mounting device comprising:
a spanning beam having a first end and a second end opposite the first end;
a first leg and a second leg, the first leg adapted to be mounted to the first end and the second leg adapted to be mounted to the second end; and
one or more fasteners adapted to secure the first leg to the first end and the second leg to the second end.

11. The mounting device of claim 10, wherein the spanning beam includes a bottom wall and one or more side walls, each side wall at an obtuse angle to the bottom wall.

12. The mounting device of claim 10, wherein the first leg and the second leg are of equal height.

13. The mounting device of claim 10, wherein the first leg and the second leg are of different heights.

14. The mounting device of claim 10, further comprising at least one pad on an undersurface of a bottom wall of a spanning beam.

15. The mounting device of claim 10, wherein the spanning beam is formed from a piece of material of uniform thickness.

16. The mounting device of claim 15, wherein the material is 0.5 millimeters to 4.0 millimeters thick.

17. The mounting device of claim 15, wherein one or more bends in the spanning beam are formed with a radius greater than or equal to the thickness of the material.

18. The mounting device of claim 15, wherein the material has a corrosion protection coating of zinc, paint, or a powder coating, or is corrosion protected by anodization or galvanization.
